(19) United States
(12) Patent Application Publication
(10) Pub. No.: US 2010/0299756 A1
(43) Pub. Date: Nov. 25, 2010

(54) SENSOR WITH A CIRCUIT ARRANGEMENT

(75) Inventors: Soenke Ostertun, Wedel (DE); Joachim Garbe, Neu Wulmstorf (DE); Johannes Toriyabe, Hamburg (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/299,950

(22) PCT Filed: May 3, 2007
(86) PCT No.: PCT/IB2007/051652

§ 371 Date: Mar. 19, 2009

(30) Foreign Application Priority Data
May 10, 2006 (EP) 06113747.7

(51) Int. Cl. G06F 21/00

(52) U.S. Cl. 726/26

(57) ABSTRACT

The invention relates to a sensor, in particular for detecting attacks on at least one signal-carrying line (11), in particular of chip cards (1), said sensor having a circuit arrangement (10) which comprises a first circuit arrangement (13) for detecting an instantaneous voltage value above a first supply voltage and a second circuit arrangement (14) for detecting an instantaneous voltage value below a second supply voltage, wherein, when a voltage value outside the range between the first and second supply voltages is detected, a signal (19) is generated and can be taken as a basis for initiating a protective measure.

The invention relates to a sensor, in particular for detecting attacks on signal-carrying lines of for example chip cards.

Chip cards, also known as smart cards, are used very frequently nowadays. Such chip cards are usually embodied as plastic cards with an integrated electronic chip which preferably includes hardware logic, a memory and a microprocessor. Such chip cards are used for carrying out certain transactions, such as money transactions in cashless payments and/or for performing an identification or authorization of a user. They can, for example, make possible access to places or services or manage accounts or allow transactions relating thereto.

Therefore, the confidential information stored on the chip card is typically not accessible from the exterior, since these data would then be subject to potential misuse. More particularly encryption data with which information to be propagated is encrypted are then of particular importance. Therefore, these encryption data are highly sensitive and therefore should be protected very well.

Chip cards of this type, but also other circuits, whose signals are to be protected for security reasons, such as circuits in the range of set-top boxes for example for pay television or DRM circuits for Digital Rights Management meanwhile, also due to the stored confidential or secret information such as encryption data, have ever more been subjected to attacks to reach the stored data.

Typically, such attacks on the security and the stored data of the chip cards are attempted by using the cards without the specifications. Use without the specifications of parameters such as temperature, supply voltage or clock frequency is then possible or because voltage spikes or incident radiated light are used. In such applications the chip of the chip card is then to have its function disturbed, so that it allows uncontrolled data access or performs uncontrolled operations via which information about the secret data can be obtained.

In order to avoid or prevent such undesired attacks on the confidential data stored on the chip, such chips include sensors which are capable of detecting voltage, temperature, frequency or voltage spikes or incident light radiation. If any unwanted attack is detected by one of these sensors, a reset is performed, that is to say, the chip restarts its boot sequence in order to again come into a defined state and also to avoid uncontrolled operations in this manner.

With the known chip cards the included detectors are used for voltage spikes for static signals, that is to say, they monitor the constancy of supply lines as is known from U.S. Pat. No. 6,542,010 B2.

From U.S. Pat. No. 6,745,331 B1 is known a detection device for chip cards by means of which an overvoltage or an undervoltage of supply lines is detected.

US 2003/0226082 A1 discloses a what is called voltage glitch detection for the detection of short-lasting voltage deviations in the supply voltage.

These publications from the state of the art relate to lines which as supply lines are at a constant supply voltage level. These measures, however, are unsuitable for signal-carrying lines.

In addition, as protection against attacks security-relevant signal lines are disposed in the lower metal layers of a multi-layer process of the chips. As a result of practical manipulations of lines lying on top of them disturbances may nonetheless be coupled in in the underlying layers, whereas these manipulations can certainly also result in the logic level in the top layers not being impeded or distorted. With a logic 1 this may be a voltage above the supply voltage or with a logic 0 a voltage below the ground level. As a result of sufficiently fast voltage variations a signal lying below this level may then be disturbed. A disturbance may also be capacitively coupled in via an additionally disposed metallization layer when sufficiently steep voltage edges in the disturbance signal are used.

It is an object of the invention to provide a sensor or a circuit arrangement which enhances the security more specifically in chip cards, so that in the event of an attack more particularly defence mechanisms suitable for the chip card can be induced to operate.

According to the invention this is achieved by means of a sensor more particularly for detecting attacks on at least one signal-carrying line more particularly of chip cards, comprising a circuit arrangement which comprises a first circuit arrangement for detecting an instantaneous voltage value above a first supply voltage and a second circuit arrangement for detecting an instantaneous voltage value below a second supply voltage, wherein, when a voltage value outside the range between the first and second supply voltages is detected, a signal is generated and can be taken as a basis for initiating a protective measure. According to the invention this achieves that it is detected when the voltage value of the monitored signal-carrying line is situated outside the permissible range after which there may be inferred that there was abusive use or an attack, respectively.

As a protective measure after detection of the fact that the permissible voltage range has been left it is suitable, if the signal pointing to an attack occurs, to perform a reset of the chip more particularly of the chip card or the complete circuit of the chip is deactivated at least at times.

It is highly advantageous if the circuit arrangement for generating the falling-short signal and/or the circuit arrangement for generating the exceeding signal are formed by at least two field effect transistors. It is also advantageous if the total circuit arrangement is built up from field effect transistors.

It is particularly advantageous if the circuit arrangement described above is integrated with the general chip logic of the chip, more particularly of the chip card. As a result of this the sensor cannot be identified so easily for targeted manipulation. This is advantageously possible because the total circuit can be built up only from logic transistors and thus also requires little space or surface, respectively.

The invention can be used not only for protecting circuits of chip cards, but in general for protecting circuits of which the signals are to be protected for security reasons, such as for example circuits in the range of set-top boxes for example for pay television or also DRM circuits for Digital Rights Management.

Advantageous further embodiments are described in the dependent claims.

The following description relating to the appended drawings, the whole given by way of non-limiting example, will provide better understanding of how the invention can be realized.

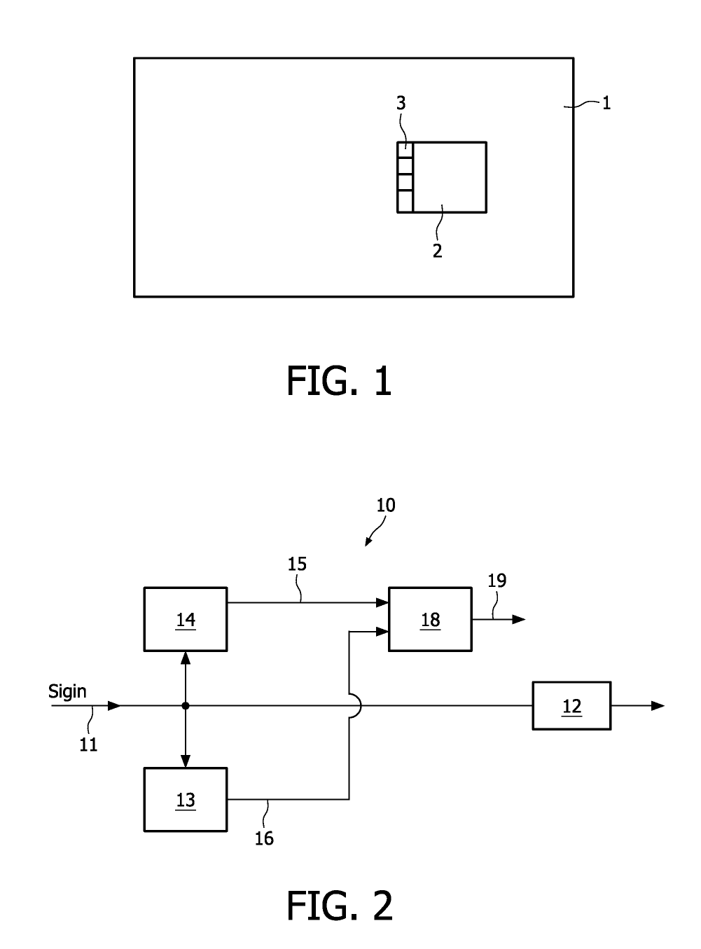

FIG. 1 gives a diagrammatic representation of a chip card;

FIG. 2 gives a diagrammatic representation of a circuit arrangement; and

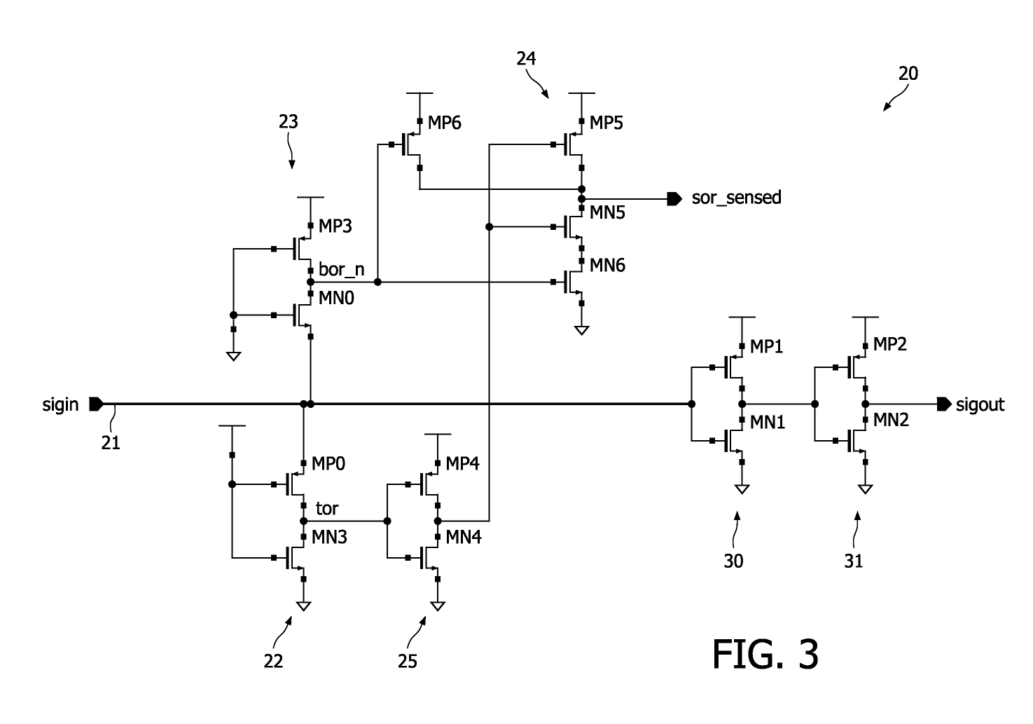

FIG. 3 shows a circuit diagram of a circuit arrangement according to the invention.

FIG. 1 gives a diagrammatic representation of a chip card 1 in which a chip 2 is arranged on the chip card 1. To this end contact faces 3 or tabs are provided by means of which the chip 2 of the chip card 1 can be brought into electrical contact with other appliances and via which data or signals can be exchanged between the respective appliance and the chip 2 of the chip card 1.

FIG. 2 gives a diagrammatic representation of an example of embodiment of a circuit arrangement 10 or of a sensor respectively for detecting attacks on signal-carrying lines 11 of a chip 2 of for example a chip card 1. In the diagram a signal-carrying line 11 is shown by means of which a further circuit arrangement 12 is supplied with data or signals or via which signals can be transmitted for example also internally. Taking the signal-carrying line 11 as a point of departure, circuit arrangements 13 and 14 are provided which monitor the signal-carrying line 11. The circuit arrangement comprising the circuits 13 and 14 monitors the signal-carrying line 11 with respect to validity check, while preferably permanent monitoring is performed as to whether the instantaneous voltage value present on the signal-carrying line 11 is situated within the range between the two supply voltages. The output of the circuit arrangement 14 (signal 15) confirms that the signal 11 to be monitored is situated above the lower supply voltage level and the output of the circuit arrangement 13 (signal 16) confirms that the signal 11 to be monitored is situated below the upper supply voltage level. The moment either of the two signals 15, 16 no longer confirms the permitted voltage range, this may be indicated as an attempt at an attack. This is advantageously possible with the aid of a NAND circuit 18 whose output signal represents the sensor signal 19. Subsequently, a reset may be carried out or the total circuit can at least at times be deactivated for safety's sake.

FIG. 3 shows a further example of embodiment of a circuit arrangement 20 according to the present invention. The circuit arrangement 20 monitors the voltage of the signal-carrying line 21 on the basis of signal sigin. A first circuit arrangement 22 forming part of the circuit arrangement 20 according to the invention is connected or coupled to the signal-carrying line 21. In the circuit arrangement 22 two transistors MP0 and MN3 are interconnected in such a way that the two drain electrodes are connected to each other and the two gate electrodes are together connected to the potential vdd! of the positive or upper supply voltage. The source electrode of transistor MP0 is connected to line 21 and the source electrode of transistor MN3 is connected to gnd! potential of the negative or lower supply voltage. The two drain electrodes of MP0 and MN3 are further connected to the inverter 25.

Also a second circuit arrangement 23 is connected or coupled to the signal-carrying line 21 as part of the circuit arrangement 20 according to the invention. Two transistors MN0 and MP3 in the circuit arrangement 23 are interconnected in such a way that the two drain electrodes are connected together and connected to the circuit 24. The two gate electrodes of MN0 and MP3 are together connected to the potential gnd! of the negative supply voltage. The source electrode of transistor MN0 is connected to line 21 and the source electrode of transistor MP3 is connected to vdd! potential of the positive supply voltage.

The two inverters 30 and 31 between the input signal sigin and the output signal sigout with their respective transistors MP1, MN1 and MP2, MN2 respectively do not, however, form part of the circuit arrangement according to the invention or the sensor respectively. They are represented only as substitutes for a circuit which is to be driven by the signal to be monitored sigin.

In normal operation the input signal sigin should carry only voltages between the positive supply voltage vdd! and the negative supply voltage gnd!, such as for example ground. The two transistors MN0 and MP0 of the circuit arrangements 22 and 23 are then always cut off independent of the voltage present. The two transistors MP3 and MN3, used as resistors, of the circuit arrangements 22 and 23 provide that the voltages bor_n at the drain electrodes of MN0 and MP3 are connected to vdd! potential and the voltage for of the drain electrodes of MN3 and MP0 to gnd! potential.

Alternatively, if sigin exceeds the supply voltage vdd! by a first predefinable threshold voltage of MP0, the voltage on for will rise accordingly and indicate an overvoltage. If sigin falls short of the supply voltage gnd! by the threshold voltage of MN0, the voltage on bor_n will drop and indicate an undervoltage.

The two sensor signals indicating an overvoltage or an undervoltage on the drain electrodes of MP0/MN3 or MP3/MN0 respectively, are combined to a common signal sor_sensed via the inverter including the transistors MP4 and MN4 and by means of the NAND circuit including the transistors MP5, MP6, MN5 and MN6. The moment sigin is in excess of the supply voltage by a threshold voltage, the signal sor_sensed will be actuated.

The circuit arrangement of the inverter 25 is interconnected such that the two gate electrodes of MP4 and MN4 are connected to one another and are interconnected to the drain electrodes of MP0 and MN3. The two drain electrodes of MP4 and MN4 are interconnected and are connected to the circuit 24. Furthermore, the source electrode of MP4 is connected to vdd! potential and the source electrode of MN4 to gnd! potential.

The NAND circuit 24 with the transistors MP5, MN5, MP6 and MN6 is then interconnected such that the two gate electrodes of MP6 and MN6 are connected to one another and are interconnected to the drain electrodes of MN0 and MP3. Furthermore the two gate electrodes of MP5 and MN5 are connected to one another and are interconnected to the drain electrodes of MP4 and MN4. The two drain electrodes of MP5 and MN5 are interconnected to the drain electrode of MP6, while the source electrode of MP6 is connected to vdd! potential and the source electrode of MP5 is also connected to vdd! potential. The source electrode of MN6 is then connected to gnd! potential. Finally, the drain electrode of MN6 is connected to the source electrode of MN5. The output line which carries the signal sor_sensed is interconnected to the drain electrodes of MN5, MP5 and MP6.

An advantageous further effect of this circuit arrangement is the limitation of the possible voltage deviations since the transistors MP0 and MN0 via the substrate terminal also act as diodes for the supply voltages.

### REFERENCE LIST

1 chip card
2 chip
3 contact faces
10 circuit arrangement
11 signal-carrying line
12 circuit arrangement
13 circuit arrangement for overvoltage check
14 circuit arrangement for undervoltage check
15 validity signal
16 validity signal
18 NAND circuit
19 sensor signal
20 circuit arrangement
21 signal-carrying line
22 circuit arrangement for overvoltage check
23 circuit arrangement for undervoltage check
24 NAND circuit
25 circuit arrangement of the inverter
30 inverter
31 inverter

1. A sensor more particularly for detecting attacks on at least one signal-carrying line (11, 21) more particularly of chip cards (1), comprising a circuit arrangement (10, 20) which comprises a first circuit arrangement (13, 22) for detecting an instantaneous voltage value above a first supply voltage and a second circuit arrangement (14, 23) for detecting an instantaneous voltage value below a second supply voltage, wherein, when a voltage value outside the range between the first and second supply voltages is detected, a signal (19) is generated on the basis of which a protective measure can be initiated.

2. A sensor as claimed in claim 1, characterized in that when the first supply voltage is exceeded by the voltage value of the signal-carrying line (11) a validity signal (15) is suppressed or an exceeding signal is generated.

3. A sensor as claimed in any one of the claim 1 or 2, characterized in that if the second supply voltage is fallen short of by the voltage value of the signal-carrying line (11) a validity signal (16) is suppressed or a falling-short signal is generated.

4. A sensor as claimed in any one of the preceding claims, characterized in that when the signal (19) occurs, a reset of the chip (2) more particularly of the chip card (1) is carried out or the complete circuit of the chip (2) more particularly of the chip card (1) is deactivated at least at times.

5. A sensor as claimed in any one of the preceding claims, characterized in that the circuit arrangement (14) for generating the falling-short signal and/or the circuit arrangement (13) for generating the exceeding signal are formed at least by means of two field effect transistors.

6. A sensor as claimed in claim 6, characterized in that the two field effect transistors are interconnected by means of their drain electrodes.
